(19) United States
(12) Patent Application Publication
(10) Pub. No.: US 2026/0227744 A1
(43) Pub. Date: Aug. 6, 2026

(54) WATCH COMPRISING ORNAMENTATION

(71) Applicant: Jass Holding ApS, Solrød Strand (DK)

(72) Inventor: Jens Stasig, Solrød Strand (DK)

(21) Appl. No.: 19/153,097

(22) PCT Filed: Jan. 15, 2024
(86) PCT No.: PCT/EP2024/050749

§ 371 Date: Aug. 1, 2025

(30) Foreign Application Priority Data
Feb. 3, 2023 (DK) PA202370064

(51) Int. Cl. G04B 47/04; G04B 19/28

(52) U.S. Cl. CPC G04B 47/04; G04B 19/286

(57) ABSTRACT

A watch (1) comprising a locking mechanism, which is configured to detachable interlock a bezel (2) and a case (9) together The locking mechanism comprises a first lock part on the bezel (2), and a second lock part associated with the case (9). The second lock part comprises a lock ring (12), and an actuator device (11) configured to actuate a reciprocating rotation of the lock ring (12), from outside the case (9), in relation to the first lock part about the central axis (X) of the bezel (2) to interlock with the first lock part in the assembled state of the watch (1), and release the second lock part from the first lock part in the disassembled state of the watch (1). The watch (1) may comprise a replaceable separate ornamentation device (3) arranged between the bezel (2) and the case (9), or the bezel can be ornamented in itself, or combinations thereof.

### CROSS REFERENCE TO RELATED APPLICATIONS

This application is a U.S. National Phase Application of PCT International Application No. PCT/EP2024/050749, filed on Jan. 15, 2024, which is an International Application of and claims the benefit of priority to Danish Patent Application No. PA202370064, filed on Feb. 3, 2023. The entire contents of these patent applications are herein incorporated by reference.

The present invention relates to a watch, or other wearable article or ornamentation assembly, comprising a locking mechanism configured to detachable interlock a bezel and a case of the watch together, which locking mechanism comprises
a first lock part on the bezel,
a second lock part associated with the case, which second lock part comprises
   a lock ring, and
   an actuator device in engagement with the lock ring and being configured to, from outside the case, to actuate a reciprocating rotation of the lock ring in relation to the first lock part about the central axis of the bezel to interlock the lock ring with the first lock part in the assembled state of the watch, and release the second lock part from the first lock part in the disassembled state of the watch.

A watch can e.g. be a wristwatch. The main function of the watch is as a wearable instrument to tell the time, but the design and decoration of the watch also makes the watch decorative wearable art. Nowadays watches are often used as fashion accessories and signature pieces. The watch instantly adds an elevated twist to any look, becoming a wearable piece that is synonymous with a style. Adding an ornamented watch to an outfit gives it an instant touch of elegance. But a conventional everyday watch, or even a permanently ornamented watch, cannot provide instant optimized finish to each and every outfit and look.

Chinese utility model no. CN201066441Y discloses a watch with a replaceable ornamentation. A groove along the edge of an upper portion of the case serves to couple the case, the watch strap and the ornamentation together using a rubber band. A U-shaped notch along the edge of the groove facilitates the assembling and disassembling of the ornamentation to the watch by means of said rubber band. The elasticity of the rubber band eventually drops and the risk that the parts of the watch separate during wearing increases the older the rubber band gets. Furthermore, the rubber band may be partly visible and disfiguring.

EP patent application no. 1 6662 341 A1 relates to a watch comprising a detachable interlocking of a bezel and a case of a watch.

Other conventional kinds of ornamentation devices for watches are provided as simple exterior attachments to the watch.

It is a main aspect of the present invention to provide a novel locking mechanism for connecting a bezel of a watch to a case of said watch.

It is a further aspect of the present invention to provide a novel locking mechanism for connecting ornamental parts to a watch, or to another wearable article or ornamentation assembly, such as pendants or broches.

In a further aspect of the present invention is provided a watch having an ornamentation device that can be replaced without tools.

In a further aspect of the present invention is provided a watch having an ornamentation device that can be replaced by the wearer of the watch himself/herself.

In a further aspect of the present invention is provided a watch having an integrated or integrateable ornamentation device.

The novel and unique features whereby these and other aspects are achieved according to the present invention consist in that the second lock part further comprises a back case configured to be mounted to a bottom part of the case and having a peripheral cut-out that allows the reciprocating rotation of the actuator device.

Accordingly, the present invention provides a novel locking mechanism that comprises a first lock part on the bezel and a second lock part associated with the case. In response to a rotational movement of a lock ring the first lock part can be locked together with the second lock part and set free again by reversing the rotational movement of the lock ring. The rotational movement of the lock ring is conveniently controlled by operating an actuator device from outside the case.

The second lock part comprises a back case that, as for a conventional watch, is configured to be mounted to a bottom part of the case to close the case from below to protect and seal the internal components of the watch against water, moisture and dust. The back case of the present invention is however also modified and differs from the conventional back case in having a peripheral cut-out, thus not just a depression or similar feature that enables the watchmaker to remove the back case using a suitable tool, but an annularly extending peripheral cut-out along a short sector of a circle of the back case.

In one embodiment of the present invention the watch may comprise an ornamentation device arranged between the bezel and the case, preferably a replaceable ornamentation that is detachable secured between the case and the bezel by means of the interlocking of the first lock part and the second lock part of the locking mechanism.

In an alternative embodiment of the present invention the bezel can be integrally formed with ornamentation or with the ornamentation device, thereby making e.g. a replaceable solid bezel the replaceable part responsible for the changing ornamentation of the watch.

In yet an embodiment of the present invention the watch according to the present invention may have a bezel configured with a plurality of spaced apart through-openings through which the replaceable ornamentation device is visible.

Alternatively, the bezel can be transparent and the replaceable ornamentation device be visible through the transparent bezel. The through-openings can have any outline and shape, be identical or different along the bezel, and be arranged with even or uneven spaces. Thus the arrangement and design of the through-openings can be made in multiple different arrangements.

It may be preferred that the replaceable ornamentation device is a decorative ring element dimensioned to match the outline of the bezel. However, in some embodiments one of, or both, the interior diameter and exterior diameter of the ornamentation device may be larger or smaller than the corresponding exterior diameter and interior diameter of the bezel, e.g. having a larger exterior diameter than the bezel to protrude at least at some positions along the perimeter of the bezel from said bezel. The bezel may be configured to facilitate such protrusions. Furthermore, the replaceable ornamentation device may have a structural pattern or 3-dimensional features that protrude through the through-openings, e.g. elevated structures that e.g. indicates the hours, constellations or any other imaginable structural or ornamental feature(s). Within the scope of the present invention the replaceable ornamentation device may have any color, structure and appearance, provided the configuration of the bezel is correspondingly configured, and provided that the replaceable ornamentation device structure-wise and geometrically matches said bezel.

The second lock part, which is associated with the case, may include that the case has at least one axially extending first through-hole configured for passage of a first lock part, e.g. a first lock part in form of at least one guide pin that protrudes axially from the bezel towards the case, optionally two, three or more guide pins.

In the assembled state of the watch the at least one guide pin can pass through the at least one axially extending first through-hole, whereby the position, in particular the angular position, of the first lock part in relation to the case becomes fixed, and the bezel becomes anti-rotational in relation to the case.

Optionally, the replaceable ornamentation device may have at least one notch aligned with the at least one axially extending first through-hole and the at least one guide pin to thereby provide control of the position and orientation of the replaceable ornamentation device in relation to the bezel and the case. This advantageous control can in a simple manner be obtained due to the at least one guide pin being firmly located in said at least one notch, and in said at least one axially extending first through-hole. In the alternative the at least one notch can instead be at least one axially extending second through-hole through the replaceable ornamentation device, which at least one axially extending second through-hole is arranged to be aligned with the at least one axially extending first through-hole through the case.

In a preferred embodiment the number of axially extending first through-holes, guide pins and notches are two, however any number is within the scope of the present invention, such as three or four. A number larger than one of axially extending first through-holes, guide pins and notches also prevents rotation of the bezel and case in relation to its other, as well as it provides for improved guidance during assembling of the ornamented watch than if the number of axially extending first through-holes, guide pins and notches is just one. However a number of one is not excluded from the scope of the present invention.

Furthermore, in a preferred embodiment the lock ring may have at least one first through-going slot for passage of the first lock part, preferably for passage of the at least one guide pin, and a ring hole for firm mounting of a free end part of the actuator device. The ring hole of the lock ring can advantageously be alignable or aligned with the peripheral cut-out of the back case in any reciprocated position of the actuator device, so that the actuator device at all times can be operated from outside the case via said peripheral cut-out to perform the required reciprocation of said actuator device to assemble and disassemble the watch, respectively, as said reciprocation brings the lock ring along. When the at least one guide pin is arranged through the at least one axially extending first through-hole of the case its/their free end reach through said at least one first through-going slot. The length of the peripheral cut-out of the back case, and of the at least one first through-going slot, restricts the maximum angular reciprocation of the lock ring, which angular reciprocation is performed by means of rotating the actuator device.

It may be preferred that the at least one first through-going slot has a lock end and an opposite release end, so that when the at least one first through-going slot is reciprocated by the rotation of the lock ring about the central axis of the bezel, the first lock part, preferably in form of the at least one guide pin, is placed either at the lock end of the at least one first through-going slot or at the release end of the at least one first through-going slot.

The lock end of the at least one first through-going slot may conveniently be dimensioned to detachably clamp around the first lock part, or be otherwise structured to hold on to the first lock part in the assembled state of the watch. The first lock part may e.g. have an enlarged free end to be moved below the lock ring at the lock end of the least one first through-going slot. The opposite release end of the at least one first through-going slot may conveniently be wider than the lock end of the at least one first through-going slot to facilitate easy release of the first lock part from the at least one first through-going slot without using any tools or time-consuming manipulation of the watch.

The actuator device may comprise a tubular actuator part mounted to the case and protruding axially from said case, and a co-operating actuator peg that extends through the ring hole of the lock ring and out of the peripheral cut-out of the back case to be accessible for actuation from outside the back case to reciprocate along the axially aligned peripheral cut-out, which reciprocation may include moving the actuator peg of the actuator device in a first direction a sector of a circle to thereby arrange the first lock part unlocked inside the release end of the first through-going slot in the disassembled state of the watch, and to rotate the lock ring by moving the actuator peg of the actuator device in a second direction opposite the first direction a suitable sector of a circle to arrange the first lock part locked inside the lock end of the first through-going slot in the assembled state of the watch, respectively.

Preferably the angular length of the sector of a circle corresponds to the angular length of the first through-going slot of the lock ring and/or that of the peripheral cut-out of the back case. The sufficient axial length of the actuator device for being manipulated from outside the case may be provided by the length of a protruding actuator peg.

In a preferred design of the case, said case may have an annular lower recess or annular lower cavity configured for accommodating at least the lock ring, and optionally for detachable securing of the back case to the case.

The second lock part may comprise an open-ended partially ring-shaped spring element arranged between the back case and the lock ring, which open-ended partially ring-shaped spring element delimits a gap between its opposite free ends. The open-ended partially ring-shaped spring element applies an axial spring force to the lock ring against the case when the back case is mounted to the case, to ensure that a free end of the first lock means remains firmly inside the at least one first through-going slot, thereby also ensuring that the bezel cannot come along when the lock ring rotates about the central axis of the bezel.

The gap may conveniently be arranged at least substantially aligned with the peripheral cut-out of the back case.

The lock ring may have at least one second through-going slot that serves to receive an upright protruding locating web of the open-ended partially ring-shaped spring element to thereby ensure that said open-ended partially ring-shaped spring element does not rotate unintended when the lock ring rotates So that the gap moves out of its at least partial axial alignment with the peripheral cut-out of the back case.

In a preferred embodiment at least one of opposite blind ends of the peripheral cut-out of the back case may have a first engagement component configured to engage a mating second engagement component on the actuator device, to thereby assist in keeping the first lock part and the second lock part firmly locked together in the assembled state of the watch. The first engagement component can e.g. be a protruding breast, a slot or an indentation in the blind end wall of the peripheral cut-out, and the second engagement means on the actuator device may be designed complementary thereto, on e.g. the actuator peg. The second engagement means can e.g. be a collar, a tab, pin or recess that mates to engage the first engagement component. However any arrangement of mating female engagement components and/or male engagement components is within the scope of the present invention.

The case may conveniently have an annular upper recess or annular upper cavity configured for accommodating the ornamentation device, and optionally for at least partially accommodating the bezel. It should however be noted that for some embodiments of watches an ornamentation device can simply be applied on top of the case below a superjacent bezel.

The present invention further relates to a method of replacing replaceable ornamentation device or replacing a replaceable bezel of the watch, as described above, which method comprises the steps of:
a) rotating the lock ring in a first direction by operating the actuator device to set the first lock part free of the second lock part,
b) removing the replaceable bezel and/or the replaceable ornamentation device,
c) replacing the replaceable ornamentation device with another replaceable ornamentation device, and/or replacing the replaceable bezel with another replaceable bezel,
d) arranging the first lock part of the replaceable bezel in engagement with the second lock part associated with the case, and
e) rotating the lock ring in a second direction opposite the first direction by operating the actuator device for the first lock part to interlock with the second lock part.

The first direction of step a) may advantageously be towards the release end of the at least one first through-going slot, and the second direction of step e) may advantageously be towards the lock end of the at least one first through-going slot.

The invention will be described in further details with references to the drawing in which:

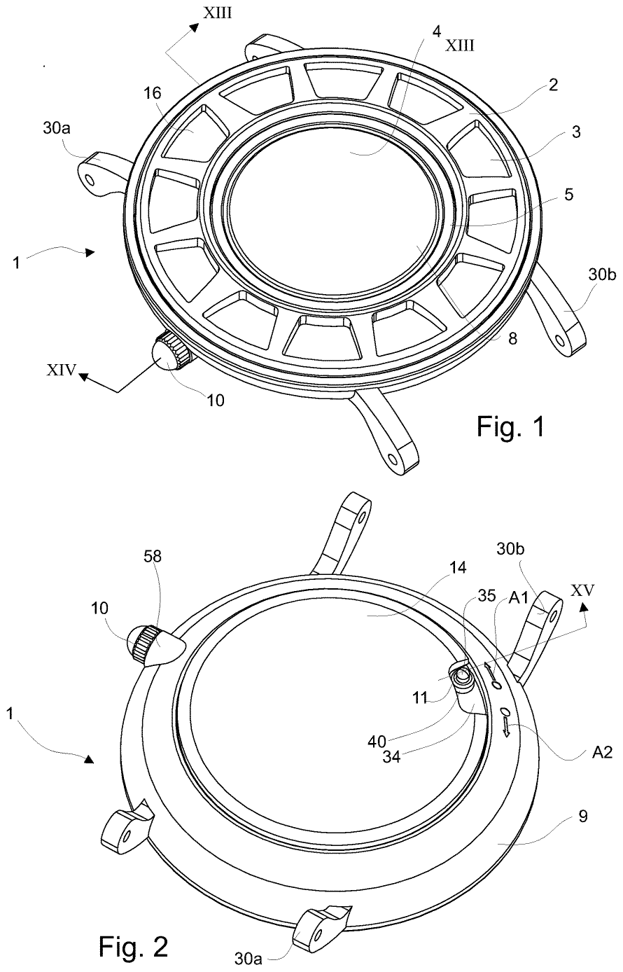

FIG. 1 is a perspective view of an embodiment of a watch seen from above,

FIG. 2 shows the same seen from below,

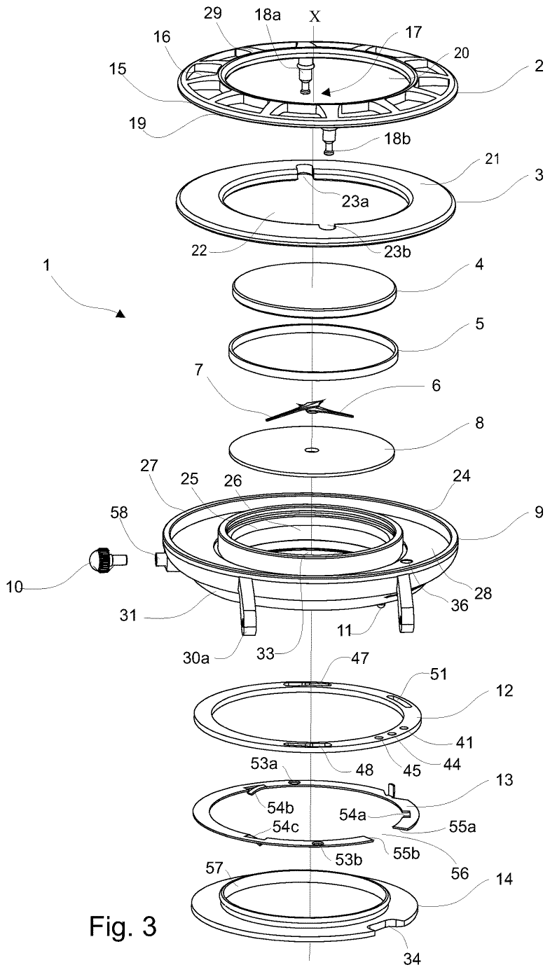

FIG. 3 is an exploded side view of the same,

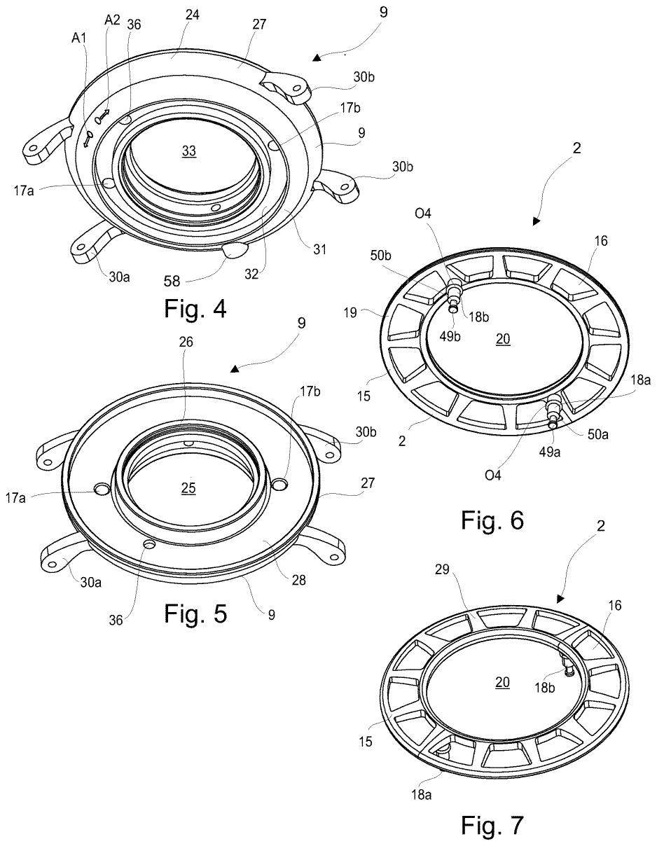

FIG. 4 shows the case in perspective view slightly from below,

FIG. 5 shows the same from above,

FIG. 6 shows the bezel in perspective view slightly from below,

FIG. 7 shows the same from above,

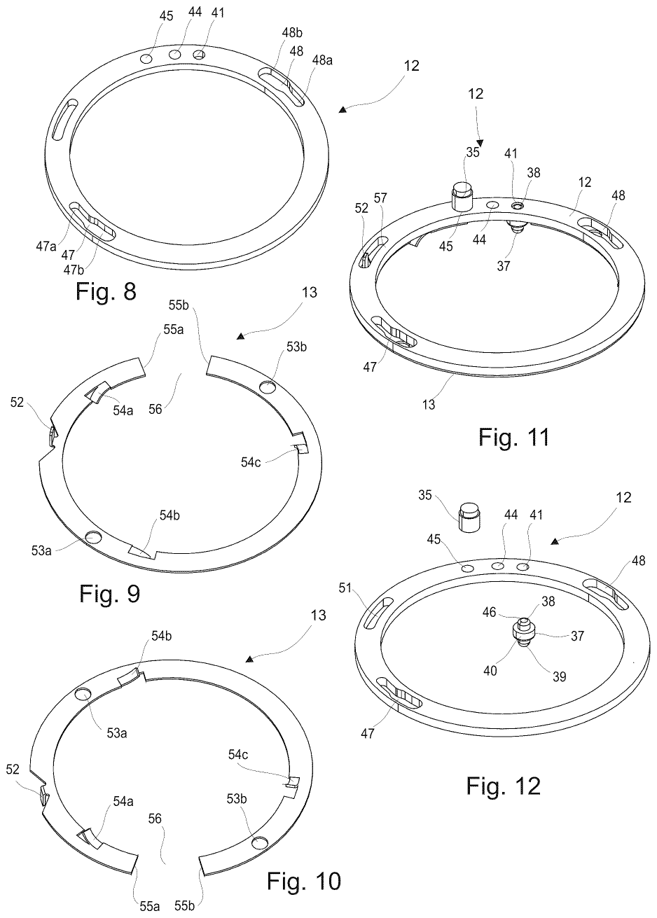

FIG. 8 shows the lock ring in perspective enlarged scale view from above,

FIG. 9 shows the open-ended partially ring-shaped spring element in perspective enlarged scale view from above,

FIG. 10 shows the same from below,

FIG. 11 is a perspective enlarged scale view of the lock ring superjacent the open-ended partially ring-shaped spring element, and a tubular actuator part of the actuator device, which tubular actuator part is a part secured to the case, which tubular actuator part is illustrated in locked state of the locking mechanism,

FIG. 12 shows the lock ring with the actuator device in partly exploded state,

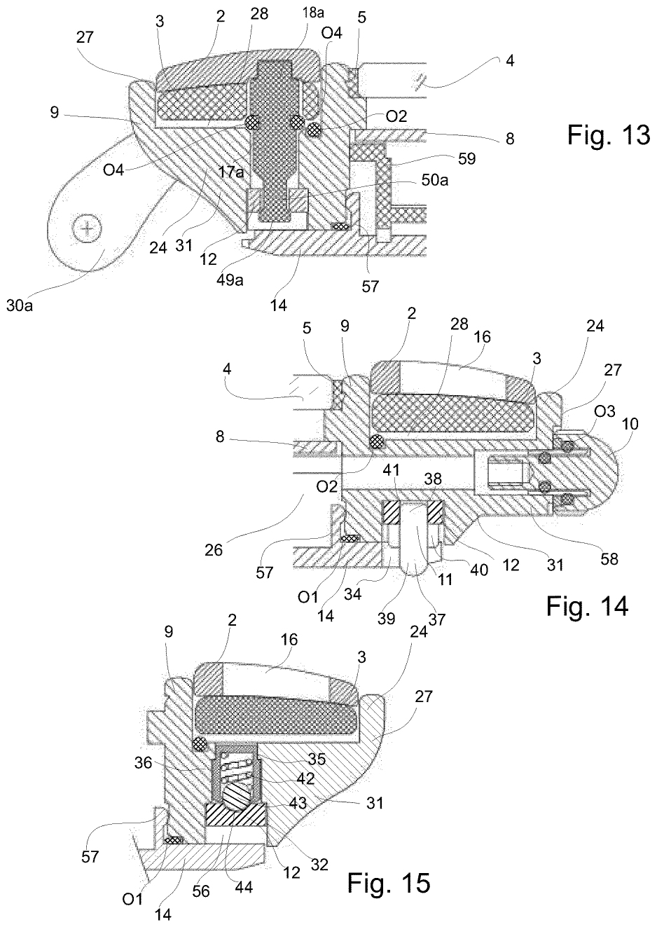

FIG. 13 is a fragment of a sectional view taken along line XIII in FIG. 1,

FIG. 14 is a fragment of a sectional view taken along line XIV in FIG. 1, and

FIG. 15 is a fragment of a sectional view taken along line XV in FIG. 2.

As shown in FIGS. 1-3 an embodiment of a watch 1 according to the present invention comprises a bezel 2, an ornamentation device 3, a crystal 4, a crystal gasket 5, an hour hand 6, a minute hand 7, a dial 8, a case 9 configured to receive a crown 10, an actuator device 11, a lock ring 12, an open-ended partially ring-shaped spring element 13, and a back case 14, all of which are centered about a common central axis X, except for the peripherally arranged crown 10 and actuator device 11. The hour hand 6 and the minute hand 7 are only seen in FIG. 3, nor does the ornamentation device 3 show any pattern, topography or information. Such information and/or ornamentation is left out for illustrative purposes and the lack of displayed information and/or ornamentation should not be construed as limiting the scope of the present invention, nor should the shown outline and configuration of the through-going openings 16 of the bezel 2 be construed as limiting the scope of the present invention.

The bezel 2, which is seen in more details in FIGS. 6 and 7, has a ring-shaped main bezel body 15 penetrated by a plurality of spaced apart through-openings 16. In the present embodiment the first lock part is provided as two diametrically opposite guide pins 18a, 18b that protrude from a lower bezel face 19.

The ring-shaped main bezel body 15 delimits a central bezel opening 20, which, in the assembled state of the watch 1, is covered by the crystal 4. The crystal gasket 5 serves as a seal between the case 9 and the crystal 4 to prevent entry of moisture and dirt, and to protect a.o. the dial 8, the hour hand 6, and the minute hand 7 from outside accidental damaging interaction.

The ornamentation device 3 has a ring-shaped main ornamentation body 21 that delimits a central ornamentation opening 22. An interior perimeter of the central ornamentation opening 22 has two diametrically opposite notches 23a,23b that receive the two diametrically opposite guide pins 18a,18b of the bezel 2.

The case 9, which is seen in more details in FIGS. 4 and 5, has a ring-shaped main case body 24 that delimits a case housing 26 for accommodation of the movement (not shown), which case housing 26 has an upper case opening 25 and an opposite lower case opening 33.

In the current embodiment of a watch 1 the ring-shaped main case body 24 has an upper case part 27 configured with an annular upper cavity 28 penetrated by diametrically first through-holes 17a,17b for passage of the diametrically opposite guide pins 18a,18b below the ornamentation device 3. In the assembled state of the watch 1 the annular upper cavity 28 accommodates the ornamentation device 3, as well as the bezel 2 on top of the ornamentation device 3, to visually expose a free upper bezel face 29 and the ornamentation (no shown) of the ornamentation device 3.

The upper case part 27 has two diametrically protruding sets of lugs 30a,30b for attachment of a watch strap (not shown).

The ring-shaped main case body 24 has a lower case part 31 opposite the upper case part 27. The lower case part 31 has an annular lower cavity 32 that accommodates the lock ring 12 and the open-ended partially ring-shaped spring element 13.

The lower case opening 33, which provides access into the lower case part 31 of the case housing 26 to mount e.g. the movement, is closed and covered by the back case 14, as shown in FIG. 2.

As further seen in FIG. 2, in the assembled state of the watch 1, the actuator device 11 protrudes axially from the annular lower cavity 32 of the case 9 aligned with, or alignable with, a peripheral cut-out 34 of the back case 14, to protrude from said peripheral cut-out 34 to be exposed sufficiently to be operated by a finger in opposite rotational first and second directions, as indicated by opposite arrows A1,A2.

The actuator device 11 is best illustrated in FIGS. 11, 12, 14 and 15. The actuator device 11 has a tubular actuator part 35, which is secured into an actuator hole 36 provided in the lower case part 31 of the case 9 in the annular lower cavity 32, as seen best in FIG. 15. The actuator device 11 further has an actuator peg 37 comprised of an upper peg end part 38, a lower peg end part 39, and an intermediate peg part 40 of larger diameter than the upper peg end part 38 and the lower peg end part 39. The lower peg end part 39 is accessible from outside the watch via the peripheral cut-out 34 of the back case 14, as seen best in FIG. 14. The upper peg part 38 is secured in a ring hole 41 in the lock ring 12, and the intermediate peg part 40 prevents the actuator peg 37 from getting upwards through the lock ring 12. The lock ring 12 can be rotated, in response to actuating the actuator device 11, a suitable angular sector of a circle in relation to the case 9 and the back case 14, by operating the lower peg end part 39 to move from side to side, as seen by arrows A1,A2 in FIG. 2.

As seen in more details in the sectional view of FIG. 15 the tubular actuator part 35 accommodates a compression spring 42 and a ball 43 facing towards the lock ring 12. The ball 43 protrudes towards the two angularly spaced apart indentations 44, 45 in the upper face of the lock ring 12, thus the face of the lock ring 12 facing the case 9, as seen in FIGS. 11 and 12, for said ball 43 to be seated in one of said indentation 44, 45 depending of the angular length the actuator peg 37 is moved and the lock ring 12 are rotated about the central axis X. The back case 14 presses the open-ended partially ring-shaped spring element 13 in tight contact with the lock ring 12, which then inherently is pressed up against the annular lower cavity 32 of the case 9, whereby the distance between the lock ring 12 and the annular lower cavity 32, and thus between the ball 43 and the lock ring 12, is kept so small that the ball 43 is placed under a compression force by the compression spring 42. The ball 43 is thus resiliently confined between the lock ring 12 and the compression spring 42 inside the tubular actuator part 35. The upper peg end part 38 may have a small peg cavity 46 that better mates the spring-biased ball 43 in the position wherein the watch 1 is disassembled and the ornamentation device 3 is replaced. Because the ball 43 is spring-biased it is able to move slightly axially to jump into the peg cavity 46 when the bezel 2 is to be set free of the case 9, and in and out of the two angularly spaced apart indentations 44,45 when the lower peg end part 39 is operated to move along the peripheral cut-out 34.

When the bezel 2 and the case 9 are to be assembled after having been disassembled the lock ring 12 is rotated by actuating the lower peg end part 39, whereby the lower peg end part 39 disengages the spring-biased ball 43 of the tubular actuator part 35, and the ball 43 is allowed to jump into spring-biased engagement with one of the indentations 44,45, or one of the indentations 44,45 after the other, and thereby being clamped between the lock ring 12 and the compression spring 42 up inside the tubular actuator part 35 due to the compression force of the compression spring 42, as discussed above.

As seen in particular in FIGS. 8, 11 and 12 the lock ring 12 further has two diametrically opposite first through-going slots 47,48 for passage of the two diametrically opposite guide pins 18a,18b. A first through-going slot 47,48 has a lock end 47a,48a, and an opposite release end 47b,48b, respectively, which is wider than the corresponding lock end 47a,48a, and optionally also wider than the largest diameter of the respective free lock section parts 49a,49b of the guide pins 18a,18b.

The guide pins 18a,18b may have a respective lock section 50a,50b between a respective free lock section part 49a,49b and the bezel 2. The lock sections 50a,50b have a diameter that is smaller than or equal to the width of the respective lock end 47a,48a of the respective first through-going slot 47,48. So the free lock section part 49a,49b of a respective guide pin 18a,18b constitutes an enlargement of the associated lock section 50a,50b, which enlargement is adapted to hold said guide pins 18a,18b inside the corresponding lock end 47a,48a by being wider than the lock sections 50a,50b, as seen in FIG. 13.

The lock ring 12 has a second through-going slot 51 configured to receive an upright protruding web 52 of the open-ended partially ring-shaped spring element 13, as seen in more details in the enlarged scale views of FIGS. 9 and 10. The open-ended partially ring-shaped spring element 13 further has third through-holes 53a,53b for receiving the guide pins 18a,18b, and three spaced apart spring elements 54a,54b,54c, which are annular segments of the open-ended partially ring-shaped spring element 13. The spring property of the annular segments are obtained by axially deflecting annular, spaced apart segments of the open-ended partially ring-shaped spring element 13 at its interior perimeter, or exterior diameter if more preferred, towards the back case 14, whereby said annular segments become able to provide an axial spring force component towards the back case 14. The open-ended partially ring-shaped spring element 13 has opposite free ends 55a,55b and a gap 56 there between, which gap 56 is aligned with the peripheral cut-out 34, so that the intermediate peg part 40 can pass through, and the lower peg end part 39 become accessible for being operated via the peripheral cut-out 34.

The back case 9 has a securing collar 57 that is configured to mount the back case 9 firmly to the case 9 via a first O-ring O1, as seen in FIG. 15. A second O-ring O2 seals in the annular upper cavity 28 between the ornamentation device 3 and the upper case part 27, as seen in FIGS. 13 and 14. Four third O-rings O3 seals around the crown 10 when inserted into the radially protruding crown bushing 58. A respective fourth O-ring O4 surrounds a respective guide pin 18a,18b to provide a seal against the bezel 2 and the ornamentation device 3.

In FIG. 13 is also seen a fragment of the holder 59 for the movement (not shown).

In the figures the watch is, only for illustrative purposes, shown without movement and watch strap. The implementation and inclusion of these components are known to the skilled person. It is however emphasized that such components are indeed part of the watch of the present invention, for said watch to be operative and wearable as a functional wrist watch. The movement and the watch strap can be of any known kind.

The present invention is not limited to any shape and outline of the case of the watch. The shape and outline of the case of the watch need e.g. not be circular. Polygonal and oval overall outlines are within the scope of the present invention. Also the lugs, which are shown in the figures for securing of the watch strap, can be made with any imaginable design, and so can the bezel, provided the design of the bezel is adapted to the design of the case, and if an ornamentation device is present the bezel matches the ornamentation device. The lugs may also be replaced with an eye to use the watch in a chain, or with a ring to use the watch as a finger watch.

Emphasize is further made that the plurality of spaced apart through-openings can have any imaginable design, be spaced arbitrarily or homogeneous, and be combinations of through-openings having different designs. The appearance of the ornamentation device may be made special in any imaginable way, e.g. by way of color, pattern, topography, or be used to provide visual information to the wearer of the watch.

In some embodiments the bezel is integral with the replaceable ornamentation device and the entire combined integral component are provided with the first lock means and constitutes a combined replaceable part.

It is also emphasized that the locking mechanism of the present invention can be used for assembling bezels and cases of watches without a replaceable ornamentation device, and for watches without any ornamentation device at all between the bezel and the case, in which embodiments the bezel may be made without the plurality of spaced apart through-openings, and the bezel be configured with or without ornamentation.

Finally it should be emphasized that although the present application claims a watch the invention can be modified for use with a piece of jewelry or trinket, such as a pendant, a broche, or a ring. The assembling and disassembling principle of the locking mechanism, thus of a first locking part of the locking mechanism on a first part of the piece of jewelry or trinket, and a second locking part of the locking mechanism on a second part of the piece of-jewelry or trinket, is directly transferable from the watch. Thus for a piece of jewelry or trinket compared to the watch the first part may replace the bezel and the second part may replace the case.

To summarize the present invention relates to a watch comprising ornamentation. The watch 1 comprises a locking mechanism, which is configured to detachable interlock a bezel 2 and a case 9 together. The locking mechanism comprises a first lock part on the bezel 2, and a second lock part associated with the case 9. The second lock part comprises a lock ring 12, and an actuator device 11 configured to actuate a reciprocating rotation of the lock ring 12 from outside the case 9 in relation to the first lock part about the central axis X of the bezel 2 to interlock with the first lock part in the assembled state of the watch 1, and release the second lock part from the first lock part in the disassembled state of the watch 1. The watch 1 may comprise a replaceable separate ornamentation device 3 arranged between the bezel 2 and the case 9, or the bezel 2 can in itself be ornamented, or combinations thereof.

What is claimed is:

1. A watch comprising a locking mechanism configured to detachable interlock a bezel and a case of the watch, wherein the locking mechanism comprises
a first lock part on the bezel,
a second lock part associated with the case, which second lock part comprises
a lock ring, and
an actuator device in engagement with the lock ring and being configured to, from outside the case, to actuate a reciprocating rotation of the lock ring in relation to the first lock part about the central axis of the bezel to interlock the lock ring with the first lock part in the assembled state of the watch, and release the second lock part from the first lock part in the disassembled state of the watch, wherein
the second lock part further comprises a back case configured to be mounted to a bottom part of the case and having a peripheral cut-out that allows the reciprocating rotation of the actuator device.

2. A watch according to claim 1, wherein the watch comprises
an ornamentation device arranged between the bezel and the case, preferably a replaceable ornamentation device, or
the bezel is integrally formed with the ornamentation device or has ornamentation.

3. A watch according to claim 1, wherein
the bezel has a plurality of spaced apart through-openings through which an ornamentation device is visible, and/or
the bezel is transparent.

4. A watch according to claim 1, wherein the second lock part includes that the case has at least one axially extending first through-hole configured for passage of the first lock part in form of at least one guide pin that protrudes axially from the bezel towards the case.

5. A watch according to claim 4, wherein the replaceable ornamentation device has at least one notch aligned or alignable with the at least one axially extending first through-hole through the case.

6. (canceled)

7. A watch according to claim 1, wherein the lock ring comprises
at least one first through-going slot for passage of the first lock part, and
a ring hole for passage of the actuator device, wherein
the at least one first through-going slot has a lock end and an opposite release end, wherein the lock end of the at least one first through-going slot is dimensioned to detachably clamp around the first lock part, and the opposite release end of the at least one first through-going slot is wider than the lock end to facilitate release of the first lock part.

8. A watch according to claim 7, wherein the actuator device comprises
a tubular actuator part that protrudes axially from the case, and
an actuator peg that extends axially through the ring hole of the lock ring and out of the peripheral cut-out of the back case to be accessible for actuation from outside the back case to reciprocate along the peripheral cut-out to rotate the lock ring in a first direction a sector of a circle to arrange the first lock part unlocked inside the release end of the first through-going slot in the disassembled state of the watch, and to rotate the lock ring in a second direction opposite the first direction a sector of a circle to arrange the first lock part locked inside the lock end of the first through-going slot in the assembled state of the watch, respectively.

9. A watch according to claim 8, wherein the angular length of the sector of a circle corresponds substantially to the angular length of the first through-going slot of the lock ring, and/or to the angular length of the peripheral cut-out of the back case.

10. A watch according to claim 1, wherein the case has an annular lower recess or annular lower cavity configured for accommodating at least the lock ring.

11. A watch according to claim 1, wherein the second lock part comprises an open-ended partially ring-shaped spring element arranged between the back case and the lock ring, which open-ended partially ring-shaped spring element delimits a gap between its opposite free ends.

12. A watch according to claim 11, wherein the gap is arranged at least substantially aligned with the peripheral cut-out of the back case.

13. A watch according to claim 2, wherein the case has an annular upper recess or annular upper cavity configured for accommodating at least the ornamentation device, and optionally for at least partially accommodating the bezel.

14. A method of replacing a replaceable ornamentation device or replacing a replaceable bezel of the watch according to any of the preceding claims comprising the steps of:
a) rotating the lock ring in a first direction by operating the actuator device to set the first lock part free of the second lock part,
b) removing the replaceable bezel and/or the replaceable ornamentation device,
c) replacing the replaceable ornamentation device with another replaceable ornamentation device, and/or replacing the replaceable bezel with another replaceable bezel,
d) arranging the first lock part of the replaceable bezel in engagement with the second lock part associated with the case, and
e) rotating the lock ring in a second direction opposite the first direction by operating the actuator device for the first lock part to interlock with the second lock part.

15. A method according to claim 14, wherein the first direction of step a) is towards the release end of the at least one first through-going slot, and the second direction of step e) is towards the lock end of the at least one first through-going slot.
